(19) United States
(12) Patent Application Publication
(10) Pub. No.: US 2023/0236029 A1
(43) Pub. Date: Jul. 27, 2023

(54) METHOD FOR MAP-BASED AUTHENTICATION CHALLENGES

(71) Applicant: Capital One Services, LLC, McLean, VA (US)

(72) Inventors: Michael Mossoba, Great Falls, VA (US); Farshid Jahed, Woodbridge, VA (US); Joshua Edwards, Philadelphia, PA (US)

(21) Appl. No.: 17/584,350

(22) Filed: Jan. 25, 2022

(51) Int. Cl. G01C 21/34; G06K 9/62; G06N 20/00; G01C 21/36; G06T 19/00

(52) U.S. Cl. CPC G01C 21/3476; G01C 21/3484; G06K 9/6215; G06N 20/00; G01C 21/3614; G01C 21/3644; G06T 19/006

(57) ABSTRACT

Map-based security authentication challenges are disclosed. A user authentication method includes prompting a user to select a past route the user traveled for authentication in response to a request to access a banking computing resource. A map corresponding to the past route is transmitted to a mobile device of the user for display on the mobile device. The user is requested to trace the past route on the map. A machine learning model is invoked to compute a similarity score between the past route and a map tracing received in response to the request the user trace the past route. The method verifies a user identity, and when the similarity score satisfies a predetermined.

### BACKGROUND

Various systems use a password, sometimes called a passcode which is secret data, typically a string of characters, usually used to confirm a user's identity. Traditionally, passwords were expected to be memorized, but the large number of password-protected services that a typical individual accesses can make memorization of unique passwords for each service impractical. Using the terminology of the NIST (National Institute of Standards and Technology) Digital Identity Guidelines, the secret is held by a party called the claimant, while the party verifying the identity of the claimant is called the verifier. When the claimant successfully demonstrates knowledge of the password to the verifier through an established authentication protocol, the verifier is able to infer the claimant's identity. Since users have to create their own passwords, it is highly likely that they will not create a secure password. It might be because users want to have a password that is easy to remember, or they are not up-to-date with password security best practices, or they use patterns to generate their passwords like using their name or birthdate in their passwords. However, using a personal computer with inexpensive multicore graphics processing units (GPUs), a hacker can try about 8 billion password combinations in a second—thousands of times faster than just a few years ago, when the processing depended on just the CPU. Because GPUs are designed for parallel computing, GPUs are much better at the large-scale mathematical operations needed for cracking passwords. Powerful password-cracking software is available for free, and hackers also have access to growing shared lists of millions of actual user passwords.

### SUMMARY

The following presents a simplified summary to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description presented later.

Briefly described, the subject disclosure pertains to a map-based user authentication. A user authentication method includes prompting a user to select a past route the user traveled for authentication in response to a request to access a banking computing resource. A map corresponding to the past route is transmitted to a mobile device of the user for display on the mobile device. The user is requested to trace the past route on the map. A machine learning model is invoked to compute a similarity score between the past route and a map tracing received in response to the request the user trace the past route. The method verifies a user identity when the similarity score satisfies a predetermined threshold to allow the user access to the banking computing resource.

In another configuration, the method requests the user trace the past route by selecting landmarks on the map. A landmark can be selected that is associated with a route traveled by the user. The user is prompted to select a location of the landmark on the map and the selected location of the landmark is received. The method receives an accuracy of the selected location as compared to an actual location of the landmark in the verifying the user identity.

In another instance, the method predicts a route representative of an archive route to be used in authenticating the user. The user is prompted to create an archive route to be used in authenticating the user in the future. A tracing of the archive route is received and stored. The archive route can be accessed from a remote store.

The method may contain other useful functions and features. For example, the user is prompted to select landmarks passed by the user while the user traces the past route on the map. The past route may have been actually travelled at least 3 years ago. The user may be requested to trace the past route on the map that further include rendering via an immersive virtual reality (VR) experience. The authenticating the user may be based on the similarity score and a password. In other aspects, the user is authenticated based on a password, and if the user is successfully authenticated based upon the password, the user is requested to trace the past route on the map. The user to is prompted to select the map tracing from a touchscreen device or an augmented reality device. In other instances, the method transmits a map corresponding to a city map showing city blocks and city streets.

Another configuration is a user authentication system. The system includes a processor coupled to a memory that includes instruction that, when executed by the processor, cause the processor to prompt a user to select a past route the user traveled for authentication in response to a request to access a banking computing resource. A map corresponding to the past route is transmitted to a mobile device of the user for display on the mobile device. The system requests the user trace the past route on the map. A machine learning model is invoked to compute a similarity score between the past route and a map tracing received in response to the request the user trace the past route. A user identity is verified when the similarity score satisfies a predetermined threshold to allow the user access to the banking computing resource.

In other instances, the system requests the user trace the past route by selecting landmarks on the map. A landmark is selected that is associated with a route traveled by the user. The user selects a location of the landmark on the map. The selected location of the landmark is received and an accuracy of the selected location is determined as compared to an actual location of the landmark in the verifying. The processor further prompts the user to select landmarks passed by the user while the user traces the past route on the map. The processor is further configured to render via an immersive virtual reality (VR) experience. The user is authenticated based on the similarity score and a password.

Another instance is a method of authenticating a user for access to a financial services application. The method renders a map to the user via a mobile device and prompts the user to select an authentication route on the map, the authentication route represents a past route traveled by the user where a threshold amount of time has passed since the user traveled the past route. A tracing of the authentication route on the map is received and determined, via machine learning, if the tracing represents the past route traveled by the user. The method compares an accuracy of the tracing of the authentication route to an archive route to produce a comparison result. The user is authenticated based upon an accuracy result of the comparison result between the authentication route and the archive route. In some instances, the user is authenticated based on the accuracy result and a password.

To the accomplishment of the foregoing and related ends, certain illustrative aspects of the claimed subject matter are described herein in connection with the following description and the annexed drawings. These aspects indicate various ways in which the subject matter may be practiced, all of which are intended to be within the scope of the disclosed subject matter. Other advantages and novel features may become apparent from the following detailed description when considered in conjunction with the drawings.

### BRIEF DESCRIPTION OF THE DRAWINGS

The accompanying drawings, which are incorporated in and constitute a part of the specification, illustrate various example methods and other example embodiments of various aspects of the invention. It will be appreciated that the illustrated element boundaries (e.g., boxes, groups of boxes, or other shapes) in the figures represent one example of the boundaries. It is appreciated that in some examples, one element may be designed as multiple elements or that multiple elements may be designed as one element. In some examples, an element shown as an internal component of another element may be implemented as an external component and vice versa. Furthermore, elements may not be drawn to scale.

FIG. 1 illustrates an overview of an example implementation.

FIG. 2 is an example map used to trace a route.

FIG. 3 is a block diagram of an example user authentication system.

FIG. 4 is a block diagram of another example user authentication system.

FIG. 5 is a block diagram of another example user authentication system.

FIG. 6 is a flow chart diagram of an example user authentication method.

FIG. 7 is a flow chart diagram of another example user authentication method.

FIG. 8 is a flow chart diagram of another example user authentication method.

FIG. 9 is a block diagram illustrating a suitable operating environment for aspects of the subject disclosure.

### DETAILED DESCRIPTION

Knowledge-based authentication usually takes the form of a password or a question from your past (e.g., name of favorite teacher). This approach often suffers from lack of memorability and can be too easy to guess if they are not sufficiently complex. A solution is proposed that allows a banking customer to use map-based routes from their life, likely only known to the banking customer, to create an authentication system and method. To create the authentication, a system prompts the banking customer to enter some locations that are highly memorable to them (e.g., childhood home, college dorm, first workplace). The system may then ask for a nearby place they would typically go (the local park, school, the grocery store, etc.) In the future, the user would be authenticated, for example, by dropping them into an interface (virtual reality (VR) device, augmented reality (AR) device, or using screen-based system (e.g., touchscreen device)) to allow a user to navigate from one location to another taking their typical route. Each advancement/turn on the map would provide additional confidence that the person is authentic. In another embodiment, a bird's eye view may be used in a similar system. Machine learning (ML) can be used to predict an authenticity score. Additionally, missteps and re-routing correctly could hurt or help the authenticity score.

Some embodiments have a user trace or select important points on a map based on a user's past history of a map route or a path that a user previously traveled and use this past route history to create authentication credentials for accessing a banking system. A feature uses a map associated with a childhood home, a previous school dormitory, or a first work location associated with the banking customer. The feature has the banking customer select a well-known route on the map that was previously traveled in the past by the banking customer and that is well known only to the banking customer. The traveled path and/or landmarks will be used to authenticate the banking customer.

Another embodiment relates to authenticating a banking customer based on their knowledge of past routes they traveled. In one instance, a banking customer may have lived at a location for many years and repeatedly traveled the same/similar route to school or work. For example, the customer may have grown up at an address for many years, attended school in the past at a dormitory address, or have worked at a first address in the past and needed to often travel a familiar route in the past that only the banking customer knows. The banking customer may desire to login/access a banking system but needs to be authenticated to access the banking system. The authentication process may be based on utilizing the banking customer's knowledge of a route the customer often traveled in the past and is only known to the customer. Because the route is likely only known to the banking customer, using knowledge of the past route traveled by the banking customer provides for very strong security by only allowing the banking customer that traveled that past route access to the banking system using knowledge of that route.

Details disclosed herein generally pertain to a way of authenticating users. An implementation includes a system for authenticating a banking customer. A server receives a request to access a banking account from a banking customer. Upon receiving the request, the server is adapted to instruct a remote electronic device operated by the banking customer to display a map associated with the banking customer. The system also requests that the banking customer trace a current traced route on the map that the banking customer traveled a threshold time in the past. A memory system stores a prior traced route that was traced on the map by the banking customer when the banking customer created the prior traced route as an authentication parameter, for example, when the banking customer created their account. Authentication logic matches the current traced route to the prior traced route and determines a confidence factor. When the confidence factor exceeds a threshold, the banking customer is permitted to access a banking account. When the confidence factor does not exceed the threshold, the banking customer is not permitted to access a banking account.

Various aspects of the subject disclosure are now described in more detail with reference to the annexed drawings, wherein like numerals generally refer to like or corresponding elements throughout. It should be understood, however, that the drawings and detailed description relating thereto are not intended to limit the claimed subject matter to the particular form disclosed. Instead, the intention is to cover all modifications, equivalents, and alternatives falling within the spirit and scope of the claimed subject matter.

“Processor” and “Logic”, as used herein, includes but is not limited to hardware, firmware, software, and/or combinations of each to perform a function(s) or an action(s), and/or to cause a function or action from another logic, method, and/or system. For example, based on a desired application or need, logic and/or processor may include a software-controlled microprocessor, discrete logic, an application specific integrated circuit (ASIC), a programmed logic device, a memory device containing instructions, or the like. Logic and/or processor may include one or more physical gates, combinations of gates, or other circuit components. Logic and/or a processor may also be fully embodied as software. Where multiple logics and/or processors are described, it may be possible to incorporate the multiple logics and/or processors into one physical logic (or processor). Similarly, where a single logic and/or processor is described, it may be possible to distribute that single logic and/or processor between multiple physical logics and/or processors.

While examples and embodiments disclosed herein are directed to banking customers and banking generally, it is to be appreciated that the spirit and scope of this innovation is not intended to be limited to the banking industry. Rather, the concepts, features, functions and benefits of the innovation can be employed in most any industry without departing from the spirit and scope of the disclosure and claims appended hereto. As such, these alternative embodiments are to be included within the scope of this specification without limit.

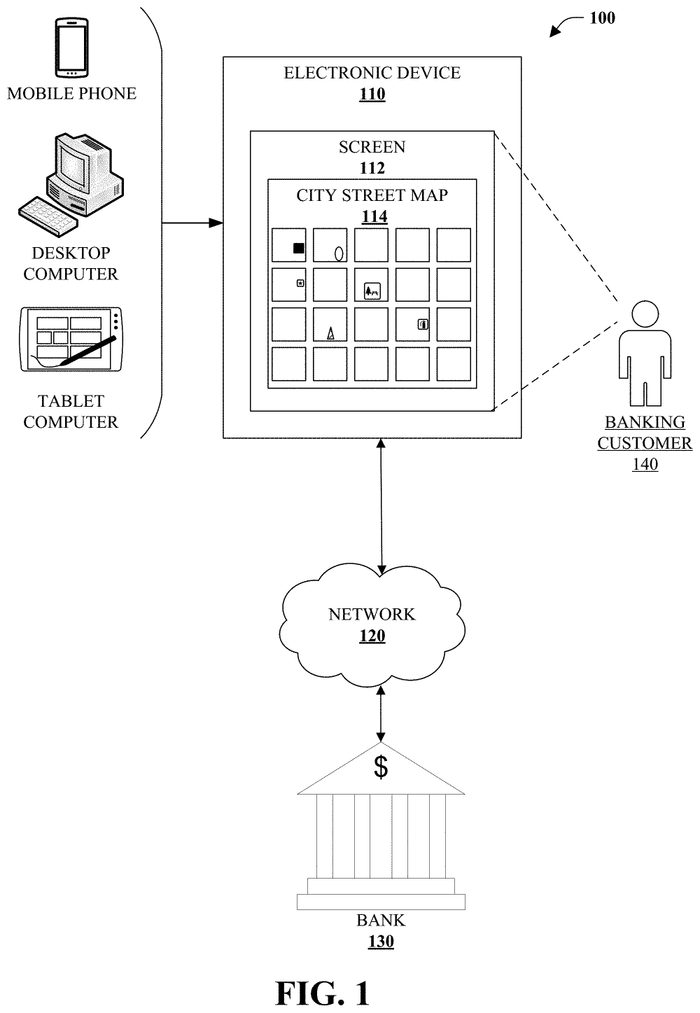

Referring initially to FIG. 1, a high-level overview of an example implementation of a banking system 100 for authenticating a banking customer 140 based on the customer's past familiarity with a map route/and or landmarks passed along that past route is illustrated. This example implementation includes an electronic device 110 that is a remote user device connected, through a network 120 to a bank 130, which includes a banking computer system. In one configuration, a map 114 is displayed on a screen 112 of the electronic device 110. As illustrated, the electronic device 110 may be any one of a mobile phone, a desktop computer, a tablet computer, or another type of electronic device or a device capable of displaying a map. A login request may be a request to access a banking account and may originate from a variety of electronic user devices operated by a banking customer 140.

In another instance, traveled path and/or landmark data may come from a banking customer 140 using a mobile telephone when that user requests to conduct a banking transaction on their phone. In yet another example, a student may conduct a banking transaction with an application on their tablet computer that requests logging into a banking computer using, at least in part, traveled path and/or landmarks to authenticate the user. In another aspect, the request includes traveled path and/or landmark data, as entered by the banking customer 140 and that corresponds to credit card transactions coming from one or more third-party merchants associated with a customer purchase that may be initiated at a computer by the banking customer 140.

The electronic device 110 may be connected to the bank 130 through a network 120. The network 120 may include portions of a local area network such as an Ethernet, portions of a wide area network such as the Internet, and may be a wired, optical, or wireless network. The stored map 114 can be stored in any suitable memory such as an optical disk memory, a non-optical disk memory, a solid state memory such as RAM memory or ROM memory, or another suitable memory.

The banking system 100 relates to authenticating a banking customer 140 based on their knowledge of past routes they traveled. In one instance, a banking customer 140 may have lived at a location for many years and repeatedly traveled the same/similar route to school or work. For example, the customer may have grown up at an address for many years, attended school in the past at a dormitory address, or have worked at a first address in the past.

A banking customer 140 may desire to login/access a banking system but needs to be authenticated by the bank 130 to access the banking system. The authentication process may be based on utilizing the banking customer's knowledge of a route the banking customer 140 often traveled in the past and is only known to the banking customer 140. Software may be running on the electronic device 110 or possibly a remote server running at the bank 130 or under control of the bank 130. Because the route is likely only known to the banking customer 140, using knowledge of the past route traveled by the banking customer 140 provides for very strong security by only allowing the banking customer 140 that traveled that past route access to the their accounts in the banking system using knowledge of that route.

In operation, a banking customer 140 is prompted by the electronic device 110 to enter or select a map representing an area the banking customer 140 lived or worked in the past such as a childhood home, school dormitory, or first place of employment. Once a map 114 has been established, the banking customer 140 is prompted to select a route by highlighting or tracing a route and/or selecting landmarks along the route that the banking customer 140 may have passed or seen while traveling that routinely traveled route. Now that this map/route path has been established as “original route credentials”, the banking customer 140 may be authenticated in the future when the customer initiates an authentication session by selecting the same route and/or landmarks along the route. In some aspects, when the selections are close enough within a confidence value (or confidence factor) to the “original route credentials” that the banking customer 140 previously selected when creating the original route, the customer is still authenticated. When the confidence values exceed a threshold value when comparing the “original route credentials” to the currently selected route, the banking customer 140 is authenticated and provided access to their account.

In other instances, the banking customer 140 may interact with their selected map through virtual reality (VR), artificial reality (AR), or a screen-based system as the banking customer 140 navigates from one location to another taking a typical route. If the same/correct landmarks are selected (or within a confidence level or factor) as the banking customer 140 used to create the authenticated path, the banking customer 140 is authenticated and provided access to the banking system 100. In some instances, a map data processor is operational to match the current traced route to the prior traced route and determine a confidence factor. The map data processor may be a specialized processor that may have custom instructions for processing map data, but the map data processor does not need to have custom instructions for processing map data.

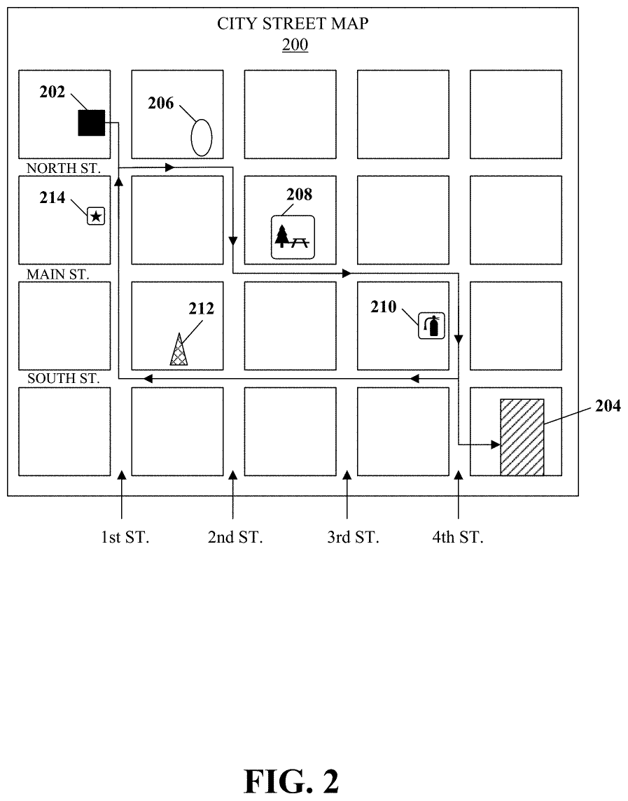

In more detail and referring to FIG. 2, this figure illustrates the map 114 of FIG. 1 in more detail. The map 200 includes left to right horizontal streets including North St., Main St., and South St. The map 200 includes vertical streets including 1st. St., 2nd St., 3rd St., and 4th St. Initially, the banking customer of FIG. 1 would be asked to input a map route from his/her past that only they have knowledge of traveling. For example, the banking customer 140 may have traveled from their home 202 (e.g., dormitory) to a school campus 204 many times in the banking customer's past history. Next, the banking customer 140 would be prompted to trace or otherwise trace out their path from home 202 to school campus 204.

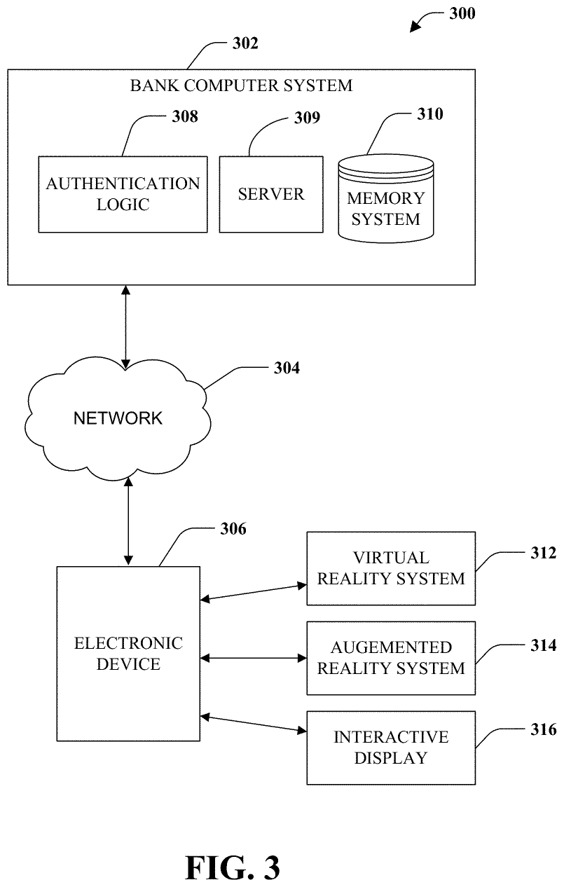

To indicate how they would travel from home 202 to the school campus 204, the banking customer 140 would trace down 1st St., and then right onto North St. As indicated, the banking customer 140 would then trace right on North Street and then down onto 2nd St. Upon reaching 2nd St., the banking customer 140 traces downward on 2nd St. to reach Main St. After reaching Main St., the banking customer 140 traces east (right) on Main St. to 4th St., and upon reaching 4^{th} St. a trace is made down 4th St. south toward the school campus 204. Upon reaching the school campus 204, the banking customer 140 may indicate they enter the school campus 204. This map 200 and the banking customer's trace from home 202 to the school campus 204 may be stored in a bank computer system 302 of FIG. 3 operated by the bank 130 of FIG. 1.

In some configurations, to provide additional security, the banking customer 140 may be asked to enter a route that they would typically travel when returning home 202 from the school campus 204. In that case, the banking customer 140 would then trace a path from the school to 4th St and then upward toward South St. Upon reaching South St., the banking customer 140 travels west (left) toward 1st St. After reaching 1st St, the banking customer 140 traces north (upward) to their home 202. After reaching their home 202, the banking customer 140 indicates they have reached their home 202 by ending their trace.

In the future, when the banking customer 140 desires to log into their banking accounts, instead of being asked solely for a traditional password, they are prompted to re-enter the path from home 202 to school campus 204 that was entered above. After entering their path from home 202 to school campus 204, the banking customer 140 is authenticated and provided access to their banking account(s). In another embodiment, for additional security, the banking customer 140 may be prompted to enter their return route from the school campus 204 to home 202. Upon entering this route and having this return route successfully authenticated by the bank 130, the banking customer 140 is authenticated and provided access to their banking account(s).

In another configuration, in addition to or instead of entering a path from the banking customer's home 202 to the school campus 204, the banking customer 140 may be prompted to enter landmarks passed along this route. For example, referring again to the map 200 of FIG. 2, the banking customer 140 would indicate that a statue 206 is passed while traveling on North St. between 1st St. and 2nd St. The customer may also indicate that a park 208 is passed while traveling on Main St. between 2nd St. and 3nd St. and a fire department 210 also passed. Of course, other landmarks may be entered as being passed between the home 202 and the school campus 204. In some instances, the banking customer 140 is optionally asked to indicate landmarks while traveling from the school campus 204 to their home 202. In this case, the banking customer 140 enters that a tower 212 is passed and a police department 214, and/or other landmarks are passed.

In the future, when the banking customer 140 desires to log into their banking account(s), instead of being asked solely for a traditional password, the banking customer 140 may be prompted to re-enter landmarks that are passed while traveling the path from home 202 to school campus 204. After entering the landmarks including the statue 206, the park 208, and the fire department 210 passed while traveling from home 202 to school campus 204, the banking customer 140 is authenticated by the bank 130. If the landmarks entered are correct, the banking customer may be provided access to their banking account(s). In another embodiment, landmarks along the return route, including the tower 212 and the police department 214, are also authenticated by the bank 130. If these additional landmark are correctly authenticated, then the banking customer 140 is then provided access to their banking account(s).

In other aspects, the map 200 and route authentication method may be combined with other user passwords. For example, a correct password would first need to be correctly entered into the banking system before the banking customer is presented a map for the entering of route information and/or selecting landmarks along the route. Similarly, each advancement/turn along a route would provide additional confidence that the banking customer is authentic. In another embodiment, a bird's eye view of a similar system using a map-trace embodiment can use machine learning (ML) to predict an authenticity score. Missteps and re-routing incorrectly could hurt or help an authenticity score.

Turning attention to FIG. 3, this figure illustrates an example system 300 for authenticating a banking customer based on a past route traveled on a map is illustrated in further detail. The example system 300 includes a bank computer system 302, a network 304, and an electronic device 306. The bank computer system 302 may be owned by a bank, the network 304 may be owned by a utility company and/or the bank, and or another entity, and the electronic device may be owned by a banking customer. Similar to the network discussed above, the network 304 may include portions a local area network such as an Ethernet, portions of a wide area network such as the internet, and may be a wired, optical, or wireless network.

The bank computer system 302 includes an authentication logic 308, a server 309 and a memory system 310. As discussed below the authentication logic 308 authenticates a banking customer based, at least in part, on objects and/or paths selected on a map. The server 309 may be any suitable server or computer and even may be a virtual server.

The memory system 310 can be any suitable system including devices capable of storing and permitting the retrieval of data. In one aspect, the memory system 310 is capable of storing, or configured to store, data representing data associated with a map, one or more routes traced/marked on the map, and landmarks on the map that may have been marked (on a map) login credentials by a banking customer. Storage media includes volatile and non-volatile, removable and non-removable media implemented in any method or technology for storage of information. Storage media includes, but is not limited to, storage devices such as memory devices (e.g., random access memory (RAM), read-only memory (ROM), magnetic storage devices (e.g., hard disk, floppy disk, cassettes, tape . . . ), optical disks and other suitable storage devices.

The electronic device 306 (e.g., computing device) may interact with a virtual reality (VR) system 312, an augment reality system 314, and/or an interactive display 316. One of the VR system 312, an augment reality system 314, and/or an interactive display 316 may be used when entering a route associated with where a banking customer had lived, gone to school, or has worked at for a threshold number of years in the past. For example, the threshold number of years in the past may be 5 years, 10 years, or another suitable number of years in the past. When authenticating the banking customer, one of the VR system 312, an augment reality system 314, and/or an interactive display 316 may also be used to re-enter a route associated with where a banking customer had lived, gone to school, or has worked at for a threshold number of years in the past.

In operation, a banking customer is prompted to enter or select a map representing an area the customer lived in the past such as a childhood home, school dormitory, or a first place of employment. Once a map has been established, the customer is prompted to select a route by selecting landmarks or highlights along the route that the customer may have passed or seen while traveling a routinely traveled route located on their selected map. Now, that an initial credential map and a route have been selected, the banking customer may be authenticated in the future when the customer initiates an authentication session. Once an authentication section is started, the custom will be presented the original map and be asked to re-trace the original (now un-displayed) route by selecting/tracing the route and/or same landmarks along a route that the customer previously believes they selected when creating the original route. The banking customer may interact with their selected map through a virtual reality (VR) system 312, an augmented reality system 314, or a screen-based system or interactive display 316 as the banking customer to navigate from one location to another taking a typical route. If the same/correct landmarks are selected and/or a similar route is traversed as the original route/landmarks, then the banking customer is authenticated and provided access to the banking system.

In some embodiments, the banking customer (or another person interacting with a computing system) might trace the map using one type of device (such as a phone in a map view). Later, when that user is logging into a system based on the original trace, that user may authenticate in a different manner such as navigating via virtual reality (VR) that may be an immersive street view, for example. Thus, the user may trace a map using a phone in a map view, using an immersive VR system 312, using an immersive augmented reality system 314, using an interactive display 316, or using another map tracing system. After creating the map trace, the user may later authenticate that trace using a phone in a map view, using an immersive VR system 312, using an augmented reality system 314, using an interactive display 316, or using another map tracing system.

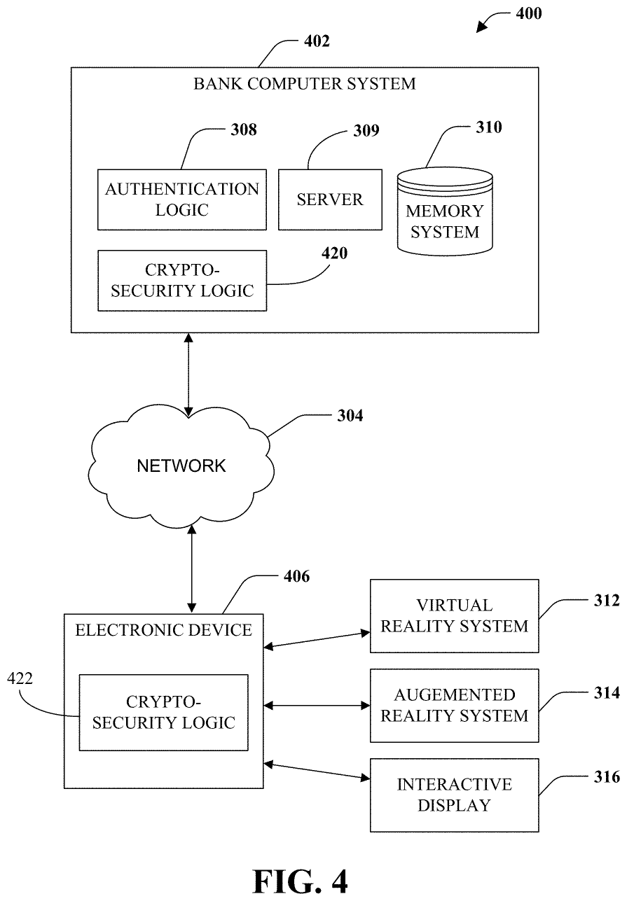

FIG. 4 illustrates another example system 400 for authenticating a banking customer based on a past route traveled (e.g., past map route) as indicated on a map. This example system 400 includes a bank computer system 402 with a crypto-security logic 420, and an electronic device 406 with a crypto-security logic 422. The other components of this example system 400 are similar to the example system 300 of FIG. 3. The system of FIG. 4 passes encrypted data back-and-forth between the bank computer system 402 and the electronic device 406. The crypto-security logic 420 and the crypto-security logic 422, encrypted and decrypt data passed between the bank computer system 402 and the electronic device 406. Using encrypted data prevents a bad actor from intercepting and using the banking customer's login data.

The crypto-security logic 420 and the crypto-security logic 422 are operable to produce encrypted data associated with a map representing a path traveled in the past and/or landmarks associated with that path. The traveled path and/or landmarks should be far enough in the past to assure that only the banking customer knows them and can easily recall them. The crypto-security logic 420 and the crypto-security logic 422 produce encrypted data by way of an encryption algorithm or function. An encryption algorithm is subsequently executed on the combination to produce an encrypted value representative of the traveled path and/or landmark data.

Stated differently, the original plaintext of the combination of encoded traveled path and/or landmark data is encoded into an alternate cipher text form. For example, the Advanced Encryption Standards (AES), Data Encryption Standard (DES), or another suitable encryption standard or algorithm may be used. In one instance, symmetric-key encryption can be employed in which a single key both encrypts and decrypts data. The key can be saved locally or otherwise made accessible by crypto-security logic 420 of the bank computer system 402 and crypto-security logic 422 of the electronic device 406. Of course, an asymmetric-key encryption can also be employed in which different keys are used to encrypt and decrypt data. For example, a public key for a destination downstream function can be utilized to encrypt the data. In this way, the data can be decrypted downstream, at a user device as mentioned earlier, utilizing a corresponding private key of a function to decrypt the data. Alternatively, a downstream function could use its public key to encrypt known data.

The example system 400 may provide an additional level of security to the authentication data by digitally signing the encrypted map route and/or landmarks along the route. Digital signatures employ asymmetric cryptography. In many instances, digital signatures provide a layer of validation and security to messages (i.e., traveled path and/or landmark data) sent through a non-secure channel. Properly implemented, a digital signature gives the bank computer system 402 and electronic device 406 reason to believe the message was sent by the claimed sender.

Digital signature schemes, in the sense used here, are cryptographically based, and should be implemented properly to be effective. Digital signatures can also provide non-repudiation, meaning that the signer cannot successfully claim they did not sign a message, while also claiming their private key remains secret. In one aspect, some non-repudiation schemes offer a timestamp for the digital signature, so that even if the private key is exposed, the signature is valid.

Digitally signed messages may be anything representable as a bit-string such as encrypted traveled path and/or landmark data. Crypto-security logic 420 of the banking computer system 402 and crypto-security logic 422 of the electronic device 406 may use signature algorithms such as RSA (Rivest-Shamir-Adleman) which is a public-key cryptosystem that is widely used for secure data transmission. Alternatively, the Digital Signature Algorithm (DSA), a Federal Information Processing Standard for digital signatures, based on the mathematical concept of modular exponentiation and the discrete logarithm problem may be used. Other instances of crypto-security logic 420 of the banking computer system 402 and crypto-security logic 422 of the electronic device 406 may use other suitable signature algorithms and functions. When the encoding and encryption of the original traveled path and/or landmark data is completed, the bank computer system 402 may transmit the encoded traveled path and/or landmark data to the user device/electronic device 406.

If a lossless encoding algorithm or scheme is used to encode traveled path and/or landmark data, then in some embodiments a hash and/or signature of the traveled path and/or landmarks may be determined before the original traveled path and/or landmark data is encoded. After the encrypted traveled path and/or landmark has been decrypted to recover the traveled path and/or landmarks, this original traveled path and/or landmarks is again hashed and/or a second signature is determined. The second hash and/or second signature can be compared to the original hash and/or signature to determine that the original traveled path and/or landmarks has been received without any loss or alteration of data.

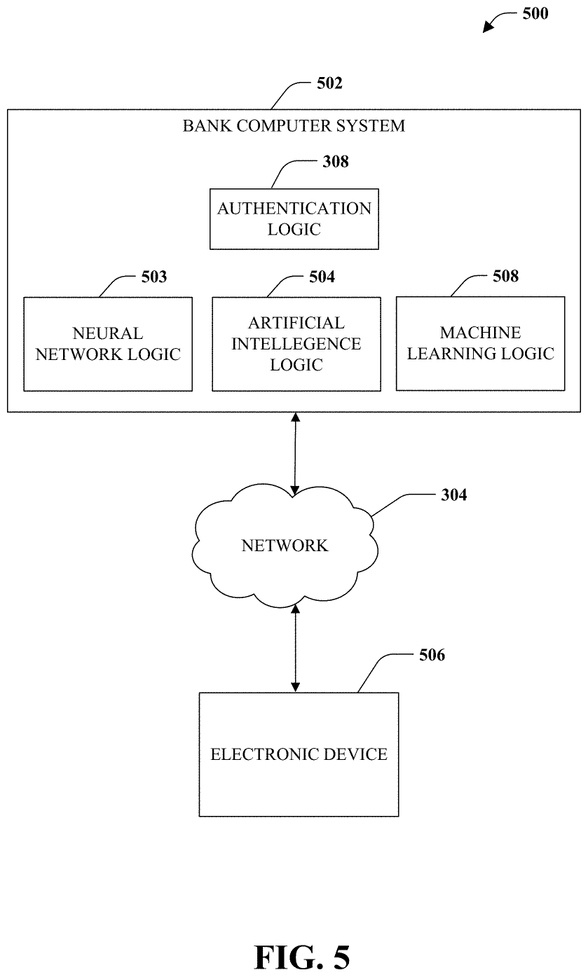

FIG. 5 illustrates another example system 500 for authenticating a banking customer based on a past route traveled as indicated on a map. This example system 500 includes a bank computer system 502 with authentication logic 308, neural network logic 503, artificial intelligence logic 504, and machine learning logic 508 and an electronic device 506. The system may also include a network 304 and an electronic device 506. The electronic device 506 is similar to the electronic device 110 of FIG. 1. The system of FIG. 5 passes encrypted data back-and-forth between the bank computer system 502 and the electronic device 506. The data represents a past route traveled by a banking customer and in some embodiments includes landmarks associated with the past route traveled, as discussed earlier.

The neural network logic 503 models a neural network that assists when determining when a route traced by a banking customer is an authentication of a route previous stored in the bank computer system as a security credential of the banking customer. A neural network is a simulated or built network or circuit of neurons, or an artificial neural network, composed of artificial neurons or nodes. Thus a neural network is either a biological neural network (theoretically), made up of biological neurons, or an artificial neural network, for solving artificial intelligence (AI) problems. The connections of the biological neurons are modeled in artificial neural networks as weights between nodes. A positive weight reflects an excitatory connection, while negative values mean inhibitory connections. All inputs are modified by a weight and summed. This activity is referred to as a linear combination. Finally, an activation function controls the amplitude of the output. For example, an acceptable range of output is usually between 0 and 1, or it could be −1 and 1. These artificial networks may be used for predictive modeling, adaptive control and applications where they can be trained via a dataset. Self-learning resulting from experience can occur within networks, which can derive conclusions from a complex and seemingly unrelated set of information. For example, where determining when a trace of a map matches a previously stored trace and/or landmarks.

The artificial intelligence logic 504 uses artificial intelligence to determine when a route traced by a banking customer is an authentication of a route previous stored in the bank computer system as a security credential of the banking customer. Artificial intelligence is the simulation of human intelligence processes by machines, especially computer systems. Specific applications of AI include expert systems, natural language processing, and speech recognition and machine vision. AI sometimes requires a foundation of specialized hardware and software for writing and training machine learning algorithms. In general, AI systems work by ingesting large amounts of labeled training data, analyzing the data for correlations and patterns, and using these patterns to make predictions about future states. In this way, a chat-bot that is fed examples of text chats can learn to produce lifelike exchanges with people, or an image recognition tool can learn to identify and describe objects in images by reviewing millions of examples. AI programming focuses on three cognitive skills: learning, reasoning and self-correction. Learning processes. This aspect of AI programming focuses on acquiring data and creating rules for how to turn the data into actionable information. The rules, which are called algorithms, provide computing devices with step-by-step instructions for how to complete a specific task. The specific task of interest for the artificial intelligence logic 504 is to determine when a route traced by a banking customer is an authentication of a route previous stored in the bank computer system as a security credential of the banking customer.

The machine learning logic 508 uses machine learning to determine when a route traced by a banking customer is an authentication of a route previous stored in the bank computer system as a security credential of the banking customer. Machine learning (ML) is the use of computer algorithms that can improve automatically through experience and by the use of data. It is seen as a part of artificial intelligence. Machine learning algorithms build a model based on sample data, known as training data, in order to make predictions or decisions without being explicitly programmed to do so. Machine learning algorithms are used in a wide variety of applications, such as in medicine, email filtering, speech recognition, and computer vision, where it is difficult or unfeasible to develop conventional algorithms to perform the needed tasks.

The aforementioned systems, architectures, platforms, environments, or the like have been described with respect to interaction between several logics and components. It should be appreciated that such systems and components can include those logics and/or components or sub-components and/or sub-logics specified therein, some of the specified components or logics or sub-components or sub-logics, and/or additional components or logics. Sub-components could also be implemented as components or logics communicatively coupled to other components or logics rather than included within parent components. Further yet, one or more components or logics and/or sub-components or sub-logics may be combined into a single component or logic to provide aggregate functionality. Communication between systems, components or logics and/or sub-components or sub-logics can be accomplished following either a push and/or pull control model. The components or logics may also interact with one or more other components not specifically described herein for the sake of brevity but known by those of skill in the art.

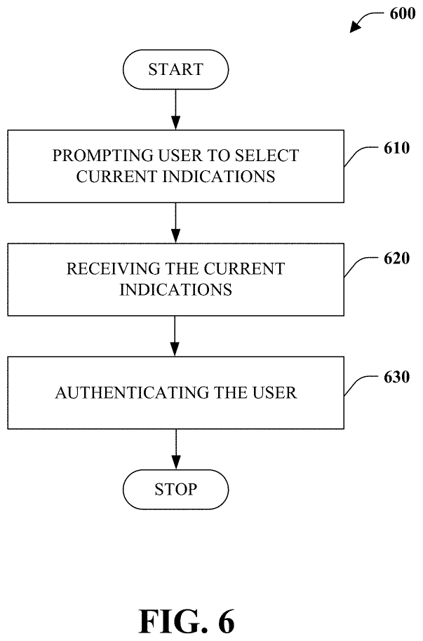

In view of the example systems described above, methods that may be implemented in accordance with the disclosed subject matter will be better appreciated with reference to flow chart diagrams of FIGS. 6-8. While for purposes of simplicity of explanation, the methods are shown and described as a series of blocks, it is to be understood and appreciated that the disclosed subject matter is not limited by order of the blocks, as some blocks may occur in different orders and/or concurrently with other blocks from what is depicted and described herein. Moreover, not all illustrated blocks may be required to implement the methods described hereinafter. Further, each block or combination of blocks can be implemented by computer program instructions that can be provided to a processor to produce a machine, such that the instructions executing on the processor create a means for implementing functions specified by a flow chart block.

Turning attention to FIG. 6, a method 600 is illustrated for authenticating users in a computer system in accordance with an aspect of this disclosure. The method 600 for authenticating users may authenticate, for example, banking system users. The authentication can be performed by the bank computer system 302 for authenticating a banking customer, as discussed above with reference to FIG. 3.

At reference numeral 610, a user is prompted to select current indications on the map related to a past route traveled by the user associated with the map. In some instances, a threshold time has passed since the user traveled the route. For example, it should be enough years in the past so that only the user may know the route used by the user, such as 5 or 10 years or more, if possible.

The current indications are received at numeral 620. The indications may be received at an organization computer from a private electronic device of an individual user. For instance, current indications may be received at the bank computer system 302 of FIG. 3 from an electronic device such as an iPad, mobile phone, laptop and the like being operated by an individual user.

The user is authenticated at numeral 630, based, at least in part, on the current indications. In one configuration, the user is authenticated when the comparison of the current indications with the initial indications exceeds a threshold level. Of course, the user is not authenticated when the comparison of the current indications with the initial indications does not exceed a threshold level.

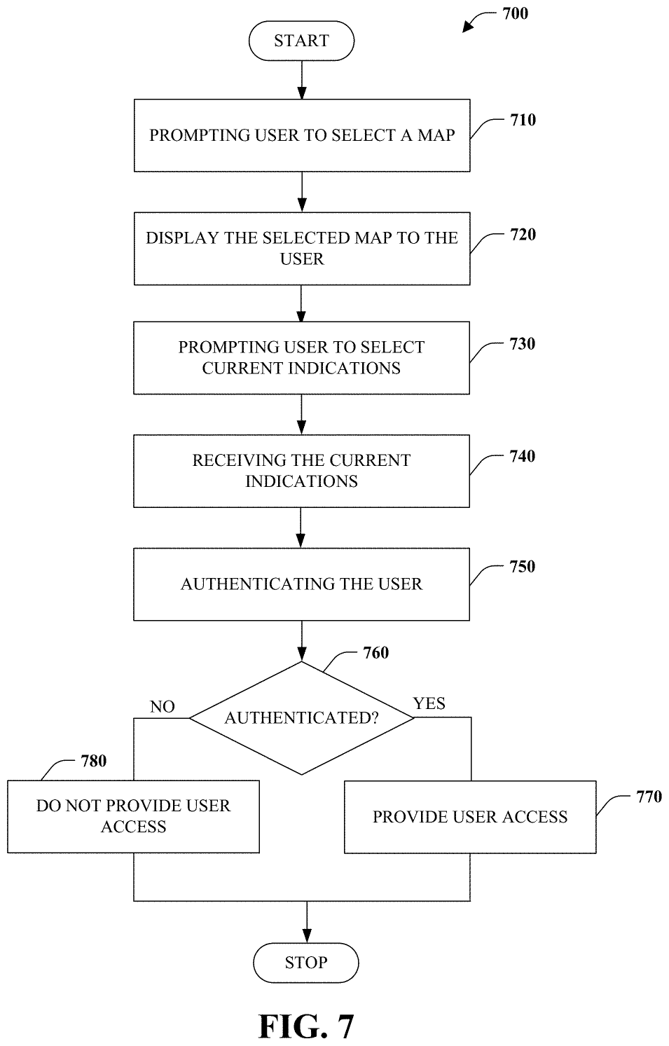

FIG. 7 depicts another method 700 for authenticating user. The method 700 can be implemented and performed by the bank computer system 302 for authenticating users.

The user is prompted, at reference numeral 710, to enter or select a map. The map is associated with the user's past. For example, it may be the map associated with a route the user took to school often in the past, a map associated with a route often traveled to a prior work place, a map associated with a route often traveled to a friend's house, and the like. It should be a map route likely only known to the user.

The selected map is displayed to the user, at reference numeral 720. The map may be displayed on an electronic device operated and owned by the user. A banking or other computer system may cause the map to be displayed on the user's electronic device.

At reference numeral 730, the method 700 prompts a user to select on a map, current indications. As mentioned before, the map is related to a past route traveled by the user associated with the map. In some instances, a threshold time has passed since the user traveled the route. For example, it should be enough years in the past so that only the user may know the route used by the user, such as a number of years or more. The more years the less likely anyone else will know the route traced by the user, thus, increasing security.

In some embodiments, the method 700 is configured to have earlier prompted the user to select a past map route (e.g., past map credentials) when creating a user account associated with the user. The past map credentials may be a trace of the past map route used when creating the account and/or landmarks along that path selected when creating that account. When authenticating the user, as discussed more below, at reference numeral 750, the past map credentials would be compared with current map credentials. The current map credentials are currently selected for a map route when currently logging into an account associated with the map.

The current indications (current map credentials) are received, at reference numeral 740. The indications may be received at an organization computer from a private electronic device of an individual user. For instance, the current indications may be received from an electronic device such as an iPad, mobile phone, laptop and the like being operated by an individual user.

The user is authenticated at reference numeral 750, based, at least in part, on the current indications. In one configuration, the user is authenticated, at reference numeral 760, when the comparison of the current indications with the initial indications (past map credentials) exceed a threshold level. Of course, the user is not authenticated when the comparison of the current indications with the initial indications do not exceed a threshold level.

When the user is authenticated the user is provided access to a banking account associated with the user, at reference numeral 770. When provided access, the user may check account balances, transfer funds, withdraw funds, and the like as understood by those of ordinary skill in the art. In other embodiments, access may be provided to non-banking accounts, such as school accounts, work accounts, etc. When the user fails authentication, at reference numeral 780, the user is not provided access to the banking account.

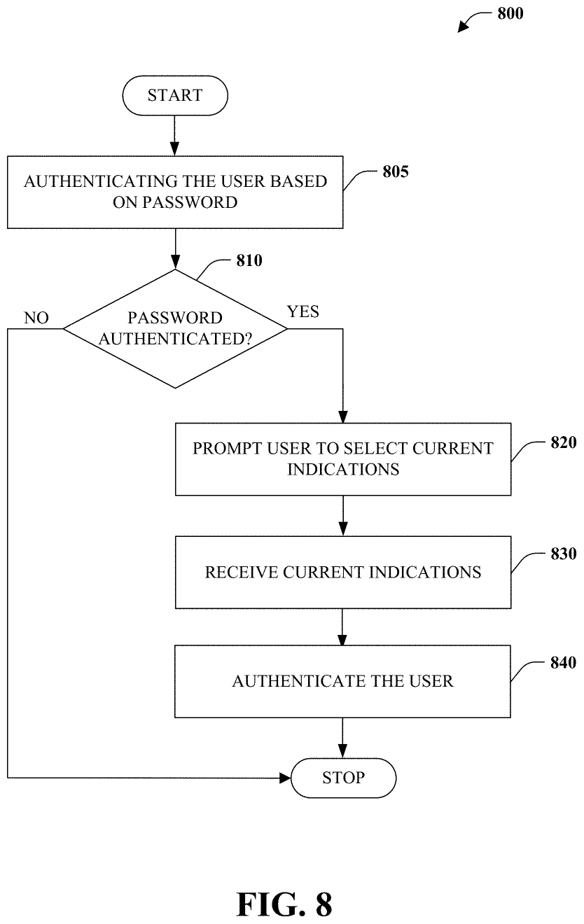

FIG. 8 depicts an example receive end of a method 800 of authenticating user. The method 800 can be also implemented and performed by the bank computer system 302 of FIG. 3.

At reference numeral 805, the user is authenticated based, at least in part, on a password. A remote electronic device operated by the user may be requesting access to a larger computer system, such as a banking computer system. The password may be any type of password as understood by those of ordinary skill in the art.

If the user is authenticated, at reference numeral 810, based on the password, the user is prompted, at reference numeral 820, to select current indications representing a route on the map. The current indications may include a traced route and/or landmarks along a route. If the password is not authenticated, the method ends. In some instances, a threshold time has passed since the user traveled the route. For example, it should be enough years in the past so that only the user may know the route used by the user, such as two years, five years, ten years, or more, if possible.

The current indications are received, at numeral 830. The indications may be received at an organization computer from a private electronic device of an individual user. For instance, current indications may be received from an electronic device such as an iPad, mobile phone, laptop and the like being operated by an individual user.

The user is authenticated at numeral 840, based, at least in part, on the current indications. In one configuration, the user is authenticated when the comparison of the current indications with the initial indications exceed a threshold level. Of course, the user is not authenticated when the comparison of the current indications with the initial indications do not exceed a threshold level.

As used herein, the terms “component” and “system,” as well as various forms thereof (e.g., components, systems, sub-systems . . . ) are intended to refer to a computer-related entity, either hardware, a combination of hardware and software, software, or software in execution. For example, a component may be but is not limited to being a process running on a processor, a processor, an object, an instance, an executable, a thread of execution, a program, and/or a computer. By way of illustration, both an application running on a computer and the computer can be a component. One or more components may reside within a process and/or thread of execution, and a component may be localized on one computer and/or distributed between two or more computers.

The conjunction “or” as used in this description and appended claims is intended to mean an inclusive “or” rather than an exclusive “or,” unless otherwise specified or clear from the context. In other words, “‘X’ or ‘Y’” is intended to mean any inclusive permutations of “X” and “Y.” For example, if “‘A’ employs ‘X,’” “‘A employs ‘Y,’” or “‘A’ employs both ‘X’ and ‘Y,’” then “‘A’ employs ‘X’ or ‘Y’” is satisfied under any of the preceding instances.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

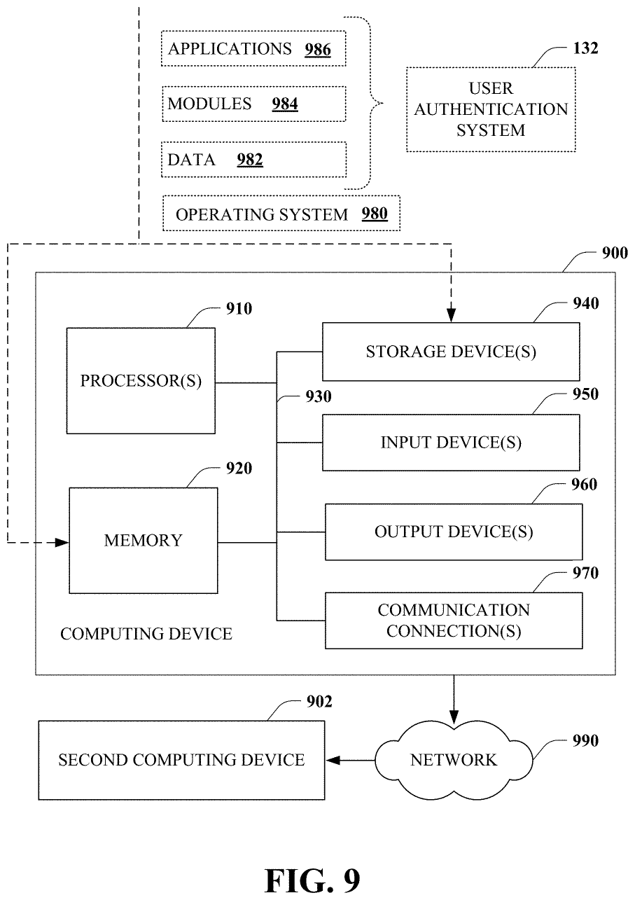

To provide a context for the disclosed subject matter, FIG. 9, as well as the following discussion, are intended to provide a brief, general description of a suitable environment in which various aspects of the disclosed subject matter can be implemented. However, the suitable environment is solely an example and is not intended to suggest any limitation on scope of use or functionality.

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things, that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, server computers, as well as personal computers, hand-held computing devices (e.g., personal digital assistant (PDA), smartphone, tablet, watch . . . ), microprocessor-based or programmable consumer or industrial electronics, and the like. Aspects can also be practiced in distributed computing environments where tasks are performed by remote processing devices linked through a communications network. However, some, if not all aspects, of the disclosed subject matter can be practiced on stand-alone computers. In a distributed computing environment, program modules may be located in one or both of local and remote memory devices.

With reference to FIG. 9, illustrated is an example a computing device 900 (e.g., desktop, laptop, tablet, watch, server, hand-held, programmable consumer or industrial electronics, set-top box, game system, compute node, . . . ). The computing device 900 includes one or more processors 910, memory 920, system bus 930, storage device(s) 940, input device(s) 950, output device(s) 960, and communications connection(s) 970. The system bus 930 communicatively couples at least the above system constituents. However, the computing device 900, in its simplest form, can include one or more processors 910 coupled to memory 920, wherein the one or more processors 910 execute various computer-executable actions, instructions, and or components stored in the memory 920.

The processor(s) 910 can be implemented with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions, or operations associated with functions, described herein. A general-purpose processor may be a microprocessor, but in the alternative, the processor may be any processor, controller, microcontroller, or state machine. The processor(s) 910 may also be implemented as a combination of computing devices, for example, a combination of a DSP and a microprocessor, a plurality of microprocessors, multi-core processors, one or more microprocessors in conjunction with a DSP core, or any other such configuration. In one embodiment, the processor(s) 910 can be a graphics processor unit (GPU) that performs calculations concerning digital image processing and computer graphics.

The computing device 900 can include or otherwise interact with a variety of computer-readable media to facilitate control of the computing device to implement one or more aspects of the disclosed subject matter. The computer-readable media can be any available media accessible to the computing device 900 and includes volatile and non-volatile media, and removable and non-removable media. Computer-readable media can comprise two distinct and mutually exclusive types: storage media and communication media.

Storage media includes volatile and non-volatile, removable and non-removable media implemented in any method or technology for storage of information such as computer-readable instructions, data structures, program modules, or other data. Storage media includes storage devices such as memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid-state devices (e.g., solid-state drive (SSD), flash memory drive (e.g., card, stick, key drive . . . ) . . . ), or any other like mediums that store, as opposed to transmit or communicate, the desired information accessible by the computing device 900. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 920 and storage device(s) 940 are examples of computer-readable storage media. Depending on the configuration and type of computing device, the memory 920 may be volatile (e.g., random access memory (RAM)), non-volatile (e.g., read only memory (ROM), flash memory . . . ), or some combination of the two. By way of example, the basic input/output system (BIOS), including basic routines to transfer information between elements within the computing device 900, such as during start-up, can be stored in non-volatile memory, while volatile memory can act as external cache memory to facilitate processing by the processor(s) 910, among other things.

The storage device(s) 940 include removable/non-removable, volatile/non-volatile storage media for storage of vast amounts of data relative to the memory 920. For example, storage device(s) 940 include, but are not limited to, one or more devices such as a magnetic or optical disk drive, floppy disk drive, flash memory, solid-state drive, or memory stick.

Memory 920 and storage device(s) 940 can include, or have stored therein, operating system 980, one or more applications 986, one or more program modules 984, and data 982. The operating system 980 acts to control and allocate resources of the computing device 900. Applications 986 include one or both of system and application software and can exploit management of resources by the operating system 980 through program modules 984 and data 982 stored in the memory 920 and/or storage device(s) 940 to perform one or more actions. Accordingly, applications 986 can turn a general-purpose computer 900 into a specialized machine in accordance with the logic provided thereby.

All or portions of the disclosed subject matter can be implemented using standard programming and/or engineering techniques to produce software, firmware, hardware, or any combination thereof to control the computing device 900 to realize the disclosed functionality. By way of example and not limitation, all or portions of the user authentication system 132 can be, or form part of, the application 986, and include one or more modules 984 and data 982 stored in memory and/or storage device(s) 940 whose functionality can be realized when executed by one or more processor(s) 910.

In accordance with one particular embodiment, the processor(s) 910 can correspond to a system on a chip (SOC) or like architecture including, or in other words integrating, both hardware and software on a single integrated circuit substrate. Here, the processor(s) 910 can include one or more processors as well as memory at least similar to the processor(s) 910 and memory 920, among other things. Conventional processors include a minimal amount of hardware and software and rely extensively on external hardware and software. By contrast, a SOC implementation of a processor is more powerful, as it embeds hardware and software therein that enable particular functionality with minimal or no reliance on external hardware and software. For example, the user authentication system 132 and/or functionality associated therewith can be embedded within hardware in a SOC architecture.

The input device(s) 950 and output device(s) 960 can be communicatively coupled to the computing device 900. By way of example, the input device(s) 950 can include a pointing device (e.g., mouse, trackball, stylus, pen, touchpad, . . . ), keyboard, joystick, microphone, voice user interface system, camera, motion sensor, and a global positioning satellite (GPS) receiver and transmitter, among other things. The output device(s) 960, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 950 and output device(s) 960 can be connected to the computing device 900 by way of wired connection (e.g., bus), wireless connection (e.g., Wi-Fi, Bluetooth, . . . ), or a combination thereof.

The computing device 900 can also include communication connection(s) 970 to enable communication with at least a second computing device 902 utilizing a network 990. The communication connection(s) 970 can include wired or wireless communication mechanisms to support network communication. The network 990 can correspond to a local area network (LAN) or a wide area network (WAN) such as the Internet. The second computing device 902 can be another processor-based device with which the computing device 900 can interact. In one instance, the computing device 900 can execute a user authentication system 132 for a first function, and the second computing device 902 can execute a user authentication system 132 for a second function in a distributed processing environment. Further, the second computing device can provide a network-accessible service that stores source code, and encryption keys, among other things that can be employed by the user authentication system 132 executing on the computing device 900.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A user authentication method, comprising:
prompting a user to select a past route the user traveled for authentication in response to a request to access a computing resource of a financial institution;
transmitting a map corresponding to the past route to a mobile device of the user for display on the mobile device;
requesting the user trace the past route on the map;
invoking a machine learning model to compute a similarity score between the past route and a map tracing received in response to the request the user trace the past route; and
verifying a user identity when the similarity score satisfies a predetermined threshold.

2. The user authentication method of claim 1, further comprising requesting the user select landmarks on the map.

3. The user authentication method of claim 1, further comprising:
selecting a landmark that is associated with a route traveled by the user;
prompting the user to select a location of the landmark on the map;
receiving the selected location of the landmark;
determining an accuracy of the selected location as compared to an actual location of the landmark; and
verifying the user identity when the accuracy satisfies a predetermined accuracy threshold.

4. The user authentication method of claim 1, wherein the prompting further comprises prompting the user to select landmarks passed by the user while the user traces the past route on the map.

5. The user authentication method of claim 1, further comprising prompting the user to select a past route traveled more than a year ago.

6. The user authentication method of claim 1, further comprising requesting the user trace the past route on the map rendered in a virtual reality environment.

7. The user authentication method of claim 1, further comprising authenticating the user based on the similarity score and a password.

8. The user authentication method of claim 1, further comprising:
verifying the user identity based on a password; and
requesting the user trace the past route after successfully verifying the user identity based on the password.

9. The user authentication method of claim 1, further comprising:
predicting a route representative of an archive route to be used in authenticating the user;
prompting the user to create the archive route to be used in authenticating the user in the future;
receiving a tracing of the archive route; and
storing the archive route.

10. The user authentication method of claim 9, further comprising accessing the archive route from a remote store.

11. The user authentication method of claim 1, further comprising transmitting a map corresponding to a city map showing city blocks and city streets.

12. The user authentication method of claim 1, further comprising:
determining the user is authorized to access the computing resource based on the user identity; and
permitting access to the computing resource.

13. A user authentication system, comprising:
a processor coupled to a memory that includes instructions that, when executed by the processor, cause the processor to:
prompt a user to select a past route the user traveled for authentication in response to a request to access a computing resource of a financial institution;
transmit a map corresponding to the past route to a mobile device of the user for display on the mobile device;
request the user trace the past route on the map;
invoke a machine learning model to compute a similarity score between the past route and a map tracing received in response to the request the user trace the past route; and
verify a user identity when the similarity score satisfies a predetermined threshold.

14. The user authentication system of claim 13, wherein the instructions further cause the processor to request the user trace the past route by selecting landmarks on the map.

15. The user authentication system of claim 13, wherein the instructions further cause the processor to:
select a landmark that is associated with a route traveled by the user;
prompt the user to select a location of the landmark on the map;
receive the selected location of the landmark;
determine an accuracy of the selected location as compared to an actual location of the landmark; and
verify the user identity when the accuracy satisfies a predetermined accuracy threshold.

16. The user authentication system of claim 13, wherein the instructions further cause the processor to prompt the user to select landmarks passed by the user while the user traces the past route on the map.

17. The user authentication system of claim 13, wherein the processor is further configured to authenticate the user based on the similarity score and a password.

18. The user authentication system of claim 13, wherein the instructions further cause the processor to:
determine the user is authorized to access the computing resource based on the user identity; and
grant access to the computing resource.

19. A method of authenticating a user for access to a financial services application, comprising:
rendering a map to the user via a mobile device;
prompting the user to trace an authentication route on the map, the authentication route represents a past route traveled by the user, wherein a threshold amount of time has passed since the user traveled the past route;
receiving a tracing of the authentication route on the map;
invoking a machine learning model to determine accuracy of the tracing compared to an archive route; and
authenticating the user based on the accuracy of the tracing.

20. The method of authenticating a user for access to a financial services application of claim 19, further comprising authenticating the user based on the accuracy of the tracing and a password.
